(19) United States
(12) Patent Application Publication
(10) Pub. No.: US 2026/0277176 A1
(43) Pub. Date: Sep. 17, 2026

(54) CONTROL DEVICE AND CONTROL METHOD

(71) Applicant: HONDA MOTOR CO., LTD., Minato-ku, Tokyo (JP)

(72) Inventors: Masanori Yoshihira, Wako-shi (JP); Tadaaki Hasegawa, Wako-shi (JP)

(21) Appl. No.: 19/547,728

(22) Filed: Feb. 24, 2026

(30) Foreign Application Priority Data
Mar. 17, 2025 (JP) 2025-042241

(51) Int. Cl. G05B 13/04; G05B 13/02

(52) U.S. Cl. CPC G05B 13/048; G05B 13/0265

(57) ABSTRACT

A control device includes a target state setting unit configured to set a target state of an object, an acquisition unit configured to acquire a current state of the object, a prediction unit configured to predict a future state of the object in a case where a difference vector between the target state and the current state is applied, and a motion generation unit configured to aggregate the current state, information on directionality from the current state to the target state, a joint angle state of the device, and a prediction result of the future state into a latent space, generate a shape change direction up to the target state, and obtain a joint angle of the device from the shape change direction.

### CROSS-REFERENCE TO RELATED APPLICATION

Priority is claimed on Japanese Patent Application No. 2025-042241, filed Mar. 17, 2025, the content of which is incorporated herein by reference.

### BACKGROUND OF THE INVENTION

### Field of the Invention

The present invention relates to a control device and a control method.

### Description of Related Art

Automated handling of flexible objects such as vinyl, paper, and cloth is an important challenge in the industrial and logistics fields. However, flexible objects have irregular shapes and unpredictable deformation characteristics, which makes it extremely difficult to perform precise manipulation by robots.

For gripping control of a flexible object, for example, it has been proposed to determine an appropriate gripping position using an image (see, for example, the following Patent Document 1). In a case where the edge of the upper surface of a flexible object (for example, a cloth towel) is deformed by a gripping portion, the pattern of deformation differs between edges which are gathered together and edges which are not gathered together, and thus a sufficient difference arises between images of portions suitable for gripping and portions unsuitable for gripping. The technique disclosed in Patent Document 1 uses image data obtained by capturing an image of a flexible object which is folded and stacked to determine whether a portion of the flexible object shown in the image data is suitable for grasping. In the technique disclosed in Patent Document 1, the gripping portion is controlled to deform the edge of the upper surface of the flexible object located at the uppermost stage, and the image data obtained by capturing an image of the flexible object with the edge of its upper surface deformed is used to determine whether the portion is suitable for grasping.

A method for gripping and positioning a flexible gripper based on three-dimensional point cloud data has been disclosed (see, for example, the following Patent Document 2). The technique disclosed in Patent Document 2 uses a pneumatic flexible gripping claw and a dual depth camera to achieve fusion of information between a camera at hand and a camera far away from hand. In the technique disclosed in Patent Document 2, three-dimensional point cloud data is used to estimate the position of an object, and a flexible gripper is used to grip the object. In the technique disclosed in Patent Document 2, a depth camera is used to acquire point cloud data of an object, a computer is used to process and analyze the point cloud data, and the RANSAC algorithm is used. In the technique disclosed in Patent Document 2, the position of an object is calculated using the RANSAC algorithm, a grip position is planned using a kinematic inverse solution, and a flexible gripper is controlled to perform the gripping operation.

[Patent Document 1] Japanese Patent No. 7,201,858

[Patent Document 2] Chinese Patent Application Publication No. 117340929

### SUMMARY OF THE INVENTION

However, in conventional techniques, methods for predicting the future shapes of flexible objects are insufficient, which makes it difficult to generate correction actions when the target is not attained.

The present invention was contrived in view of the above problems, and an object thereof is to provide a control device and a control method which make it possible to ascertain a target unattained region, predict forward-looking deformation, and improve the accuracy of robot manipulation.

In order to solve the above problem and achieve such an object, the present invention adopts the following aspects.
(1) According to an aspect of the present invention, there is provided a control device configured to manipulate an object using a device having controllable joints, the control device including: a target state setting unit configured to set a target state of the object; an acquisition unit configured to acquire a current state of the object; a prediction unit configured to predict a future state of the object in a case where a difference vector between the target state and the current state is applied; and a motion generation unit configured to aggregate the current state, information on directionality from the current state to the target state, a joint angle state of the device, and a prediction result of the future state into a latent space, generate a shape change direction up to the target state, and obtain a joint angle of the device from the shape change direction.
(2) The aspect of the above (1) may further include a motion control unit configured to control the device to the obtained joint angle, and the motion generation unit may aggregate a device status resulting from controlling the device and a state of the object after the object is deformed by the device into a latent space, and output a new shape change direction to the target state.
(3) The aspect of the above (1) or (2) may further include: a target attainment determination unit configured to compare the target state with the current shape, specify an unattained region that has not yet attained the target state, assign, to the unattained region, a guideline indicating that stretching a cloth in this direction brings the cloth closer to a target, abstract the guideline as a force vector to be treated as a virtual external force, and calculate a degree of target attainment; and a deformation prediction unit configured to predict deformation of the object due to the virtual external force using the acquired current state of the object, and the motion generation unit may use the degree of target attainment calculated by the target attainment determination unit and a shape of the object after application of the virtual external force predicted by the deformation prediction unit to aggregate a prediction result of the future state into the latent space, generate a shape change direction up to the target state, and obtain a joint angle of the device from the shape change direction.
(4) In the aspect of any one of the above (1) to (3), the motion generation unit may map a shape guidance guideline suggested in the latent space to a target position and direction of the device, and then obtain a joint angle sequence using an inverse kinematics solver.
(5) The aspect of any one of the above (1) to (4) may further include a learning unit configured to re-train a control model of the device using, as a dataset for imitation learning, a sequence of joint angles generated on the basis of a latent representation expressed in the latent space and the prediction result of the future state after application of a virtual external force.
(6) In the aspect of the above (3), the acquired current state of the object may include point cloud data of the object and information indicating an external force, and the deformation prediction unit may use the point cloud data of the object and the information indicating an external force to estimate a three-dimensional shape of the object using a position vector as an external force, and predict deformation due to the external force using a graph neural network (GNN).
(7) In the aspect of the above (3), the target attainment determination unit may use information on position and curvature on a mesh to calculate the degree of target attainment between the object and another object using a pair of nodes in a graph representation.
(8) According to an aspect of the present invention, there is provided a control method for manipulating an object using a device having controllable joints, the control method including: a target setting step of setting a target state of the object; an acquisition step of acquiring a current state of the object; a prediction step of predicting a future state of the object in a case where a difference vector between the target state and the current state is applied; and a motion generation step of aggregating the current state, information on directionality from the current state to the target state, a joint angle state of the device, and a prediction result of the future state into a latent space, generating a shape change direction up to the target state, and obtaining a joint angle of the device from the shape change direction.
(9) The aspect of the above (8) may further include: a motion control step of controlling the device to the obtained joint angle; and a step of aggregating a device status resulting from controlling the device and a state of the object after the object is deformed by the device into a latent space, and outputting a new shape change direction to the target state.
(10) The aspect of the above (8) or (9) may further include a re-training step of re-training a control model of the device using, as a dataset for imitation learning, a sequence of joint angles generated on the basis of a latent representation expressed in the latent space and the prediction result of the future state after application of a virtual external force.

According to the aspects of the above (1) to (10), it is possible to ascertain a target unattained region, predict forward-looking deformation, and improve the accuracy of robot manipulation.

### BRIEF DESCRIPTION OF THE DRAWINGS

FIG. 1 is a diagram illustrating a configuration example of a control system of an embodiment.

FIG. 2 is a flowchart processing performed by a control device of the embodiment.

FIG. 3 is a diagram illustrating an example in which creased paper is spread and placed on a table.

FIG. 4 is a diagram illustrating a configuration example of an object detection relationship prediction unit.

FIG. 5 is a diagram illustrating an example of a result obtained by performing a segmentation process on an image captured in a state where a handkerchief with creases or the like is present in a working space, and an example of performing a labeling process.

FIG. 6 is a diagram illustrating an example of graph representation and an example of the labeling process.

FIG. 7 is a diagram illustrating a configuration example of a target attainment determination unit.

FIG. 8 is a diagram illustrating a target attainment determination process and a virtual external force.

FIG. 9 is a diagram illustrating a configuration example of a deformation prediction unit.

FIG. 10 is a diagram illustrating a configuration example of a motion generation unit.

FIG. 11 is a diagram illustrating an example of a processing flow of the control device of the embodiment.

FIG. 12 is a diagram illustrating an example of a schematic processing procedure for re-learning using imitation learning data.

FIG. 13 is an example of wrinkled or creased paper before stretching.

FIG. 14 is a diagram illustrating an example of a current shape and a shape after application of a virtual external force.

### DETAILED DESCRIPTION OF THE INVENTION

Hereinafter, an embodiment of the present invention will be described with reference to the accompanying drawings. In the drawings used in the following description, the scale of each component has been appropriately changed in order to make each component recognizable.

In all the drawings used to describe the embodiment, elements having the same functions are denoted by the same reference numerals and signs, and thus description thereof will not be repeated.

The wording “on the basis of XX” used in this specification means “based on at least XX,” and also includes cases based on other elements in addition to XX. The wording “on the basis of XX” also includes a case based on an arithmetic operation or processing being performed on XX without being limited to a case in which XX is used directly. The term “XX” refers to any element (for example, any information).

### Overview

In the present embodiment, a guideline indicating that, for example, “stretching a flexible object in this direction brings it closer to the target” is assigned to an unattained portion, and this is treated as a force vector, making it easier to model the deformation behavior of a cloth under the action of an external force. In the present embodiment, such a force vector is referred to as a “virtual external force.” The “virtual external force” is not an actual physical force measurement, but a “conceptual feedback vector” that regards the difference from the target state as a force. In the present embodiment, the unattained region is redefined as a virtual external force to enable future shape prediction, and the unattained portion is treated as a new abstract representation called a virtual external force, rather than as a mere error or defect. In the present embodiment, a guideline indicating that, for example, “stretching a flexible object in this direction brings it closer to the target” is assigned to an attained portion, and this is treated as a force vector, making it easier to model the deformation behavior of the flexible object under the action of external force.

### Configuration Example of Control System

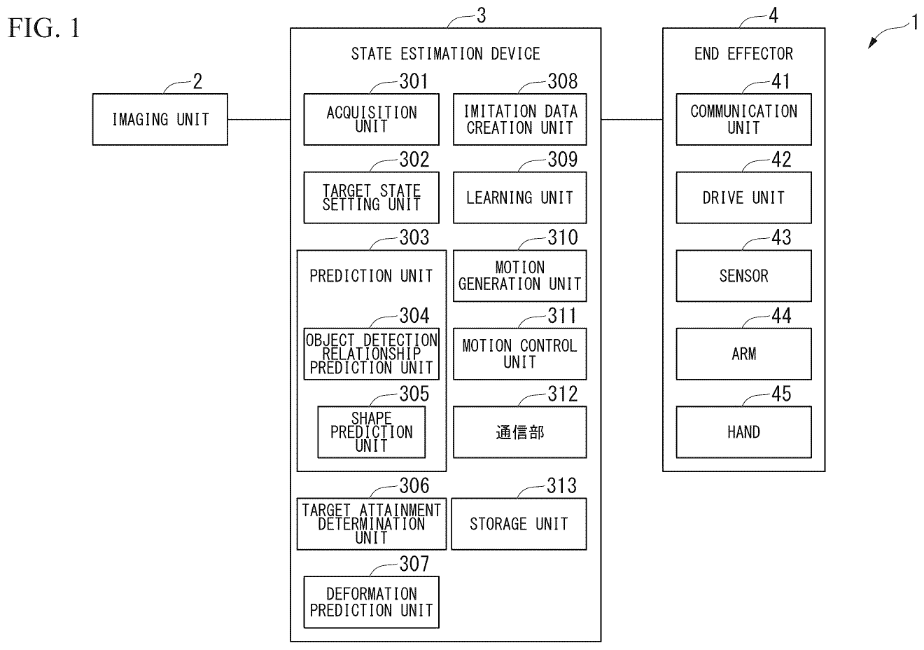

FIG. 1 is a diagram illustrating a configuration example of a control system of the present embodiment.

A control system 1 includes, for example, an imaging unit 2, a control device 3, and an end effector 4 (device).

The control device 3 includes, for example, an acquisition unit 301, a target state setting unit 302, a prediction unit 303, a target attainment determination unit 306, a deformation prediction unit 307, an imitation data creation unit 308, a learning unit 309, a motion generation unit 310, a motion control unit 311, a communication unit 312, and a storage unit 313. The prediction unit 303 includes, for example, an object detection relationship prediction unit 304 and a shape prediction unit 305.

The end effector 4 includes, for example, a communication unit 41, a drive unit 42, a sensor 43, an arm 44, and a hand 45.

The control device 3 and the imaging unit 2 are connected to each other by wire or wirelessly. The control device 3 and the end effector 4 are connected to each other by wire or wirelessly.

The imaging unit 2 captures an image including an object to be worked. The imaging unit 2 may include both a two-dimensional camera and a depth camera or a three-dimensional scanner. The imaging unit 2 may be a depth camera that can also obtain depth information, or may be a two-dimensional RGB (red-green-blue) camera and a rangefinder. The imaging unit 2 captures moving images or still images on a frame-by-frame basis. The imaging unit 2 may be installed in the working environment. The number of imaging units 2 may be two or more.

The acquisition unit 301 acquires the current state of an object by acquiring an image captured by the imaging unit 2 and a detection value detected by the sensor 43.

The target state setting unit 302 sets the target state of the object. The target state may be stored in advance in the storage unit 313, or may be obtained by inputting the image and training data into a trained model.

The prediction unit 303 predicts a future state in a case where a virtual external force, which is a difference vector between a target state and a current state, is applied. The number of object detection relationship prediction units 304 and the number of shape prediction units 305 may each be plural.

The object detection relationship prediction unit 304 extracts an object from a captured image. The object detection relationship prediction unit 304 estimates the relationship (for example, position, distance, direction, or the like) between the extracted object and another object. The object detection relationship prediction unit 304 is, for example, a trained model, and is trained in advance using a captured image as input data and using information indicating the object and its relationship as training data.

The shape prediction unit 305 predicts the shape of the object. The shape prediction unit 305 is, for example, a model, and is trained in advance using the data output by the object detection relationship prediction unit 304 as input data and using the shape of the object as training data.

The target attainment determination unit 306 determines whether the shape of the object has attained the target state on the basis of the information output by the shape prediction unit 305. A determination method will be described later.

The deformation prediction unit 307 predicts, for example, the three-dimensional shape of the object in the next frame. The deformation prediction unit 307 includes, for example, an encoder, a GNN, a decoder, a database, a loss function unit, and the like.

The imitation data creation unit 308 adds the new joint angle sequence generated by the motion generation unit 310 as data for imitation learning.

The learning unit 309 re-trains a robot control model (a control model of the device) using data for imitation learning stored in the imitation data creation unit 308.

The motion generation unit 310 includes, for example, an encoder, a decoder, and a denoising sequence. The motion generation unit 310 uses the decoder to calculate the physical target point and direction to be attained by the end effector 4 by the latent representation. The motion generation unit 310 calculates the joint angle sequence attaining the target point using inverse kinematics (IK), or directly generates the joint angle sequence using a trained decoder.

The motion control unit 311 causes the end effector 4 to execute the obtained trajectory, thereby connecting it to an actual operation.

The communication unit 312 acquires the detection result detected by the sensor 43 of the end effector 4. The communication unit 312 outputs the motion instruction generated by the motion generation unit 310 to the end effector 4.

The storage unit 313 stores algorithms, formulas, predetermined values, and the like used by each processing unit. The storage unit 313 stores algorithms, constraints, mathematical expressions, predetermined values, and the like required for generating motions. The storage unit 313 stores the positions where the sensor 43 is attached, identification information for identifying each sensor, the type of sensor, and the like in association with each other.

The end effector 4 includes, for example, one arm 44 and the hand 45.

The communication unit 41 outputs the detection result detected by the sensor 43 to an object recognition device 3A. The communication unit 41 acquires an operation instruction from the object recognition device 3A.

The drive unit 42 includes, for example, an actuator and a drive circuit, and is attached to each joint of, for example, the arm 44 and the hand 45.

Examples of the sensor 43 include a tactile sensor that detects a force applied to the finger sections or palm, a force sensor that detects three-axis force applied to the fingers and torque around each axis, a posture sensor that detects the joint angles of the arm 44 and the joint angles of each finger, and the like.

The arm 44 includes a joint. The arm 44 has one end connected to, for example, a base, and the other end connected to the hand 45 through the joint.

The hand 45 includes, for example, two or more finger sections. The hand 45 may include a palm. Each finger section includes a joint.

### Processing Procedure

Next, an example of a processing procedure during work will be described.

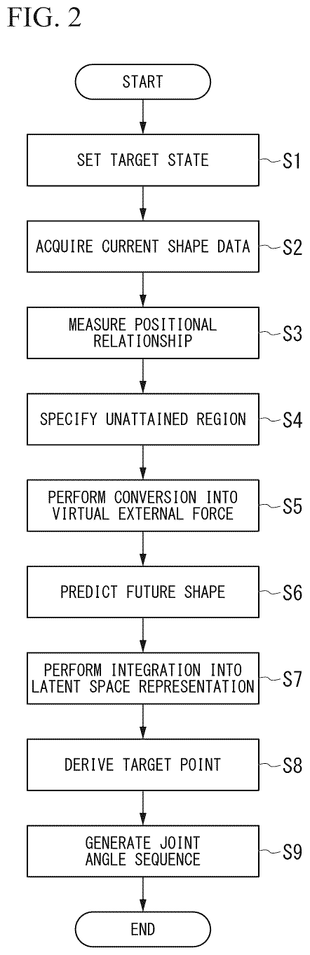

FIG. 2 is a flowchart of processing performed by the control device of the present embodiment.

(Step S1) The target state setting unit 302 sets the target state of the object. The target state may be stored in advance in the storage unit 313 as image data, or may be defined in, for example, a text format or the like and stored in advance in the storage unit 313.

(Step S2) The acquisition unit 301 acquires the current state of an object by acquiring an image captured by the imaging unit 2 and a detection value detected by the sensor 43.

(Step S3) The object detection relationship prediction unit 304 detects the region of the object from the acquired image. The shape prediction unit 305 estimates the current shape using the information output by the object detection relationship prediction unit 304. Next, the object detection relationship prediction unit 304 estimates the positional relationship between the object and another object.

(Step S4) The object detection relationship prediction unit 304 compares the target state with the current shape of the detected object, and specifies a region that has not yet attained the target (unattained region).

(Step S5) The target attainment determination unit 306 abstracts and converts the unattained region into a virtual external force.

(Step S6) The deformation prediction unit 307 inputs the predicted current shape and the converted virtual external force into the GNN, predicts how the flexible object will change from its current shape due to the virtual external force, and obtains the future shape.

(Step S7) The motion generation unit 310 inputs the current shape, directionality information (guidance vector), joint angle state, and the like to the transformer in addition to the GNN output (future shape prediction), and integrates them into a latent space representation. The latent space is a space that cannot be observed from data, for example, a multidimensional space that extracts the structure of data, captures its features, and represents it in a compressed form.

(Step S8) The motion generation unit 310 uses a decoder to calculate the physical target point and direction to be attained by the end effector from the integrated latent representation.

(Step S9) The motion generation unit 310 calculates a joint angle sequence attaining the target point using inverse kinematics (IK), or directly generates the joint angle sequence using a trained decoder.

### Setting of Target State

Next, the setting of the target state and the unattained region will be described.

In the present embodiment, the target state is, for example, a state in which a flexible object is in a predetermined state relative to another object. Therefore, the target state differs depending on the flexible object and the task.

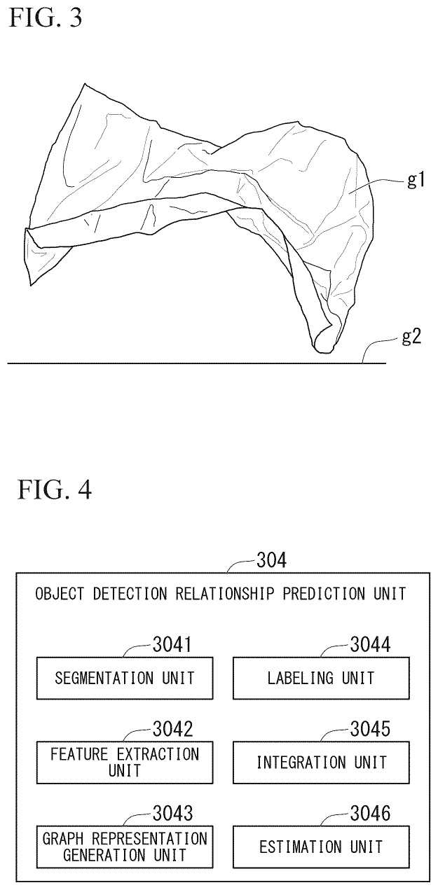

FIG. 3 is a diagram illustrating an example in which creased paper is spread and placed on a table. The reference sign g1 denotes the creased paper, and the reference sign g2 denotes the table.

For example, in a case where the flexible object is paper with creases or wrinkles, the task involves, for example, smoothing out the wrinkles and laying the paper flat on the table. The target state in such a case is to smooth out all wrinkles in the paper so that, all surfaces are in contact with the table, but this is difficult because the object being acted upon is flexible and there is a possibility that it may tear. Therefore, the target state is, for example, a state in which wrinkles have been smoothed out to a certain extent and the distance between the table and the paper is within a predetermined value, a state in which the thickness of the paper has reached a predetermined value, or the like. The unattained region is a region where the distance between the table and the paper is not within a predetermined value, or a region where the thickness of the paper has not reached a predetermined value.

Alternatively, for example, in a case where the flexible object is a folded flexible plastic bag, the task involves, for example, unfolding the folded flexible plastic bag, setting the bag inside a plastic bucket, folding part of the bag over the rim of the plastic bucket to cover it, or the like. The target setting of such a task is, for example, a state in which the bag is folded over and covers the rim of the plastic bucket. The uncovered region is an unattained region.

In the present embodiment, an object is detected from an image, and the target state setting unit 302 sets a target state in accordance with the type of flexible object which is a detected object and the task content. The object to be detected is not only a flexible object, but also other objects, such as, for example, a table, a wall, a plastic bucket, and the end effector 4.

The target state may be stored in advance in the storage unit 313 in association with the type of flexible object and the task content, or may be acquired from a server or cloud, for example, through a network before the work and used.

### Positional Relationship

Next, the positional relationship between a first object and a second object will be described.

FIG. 4 is a diagram illustrating a configuration example of the object detection relationship prediction unit.

The object detection relationship prediction unit 304 includes, for example, a segmentation unit 3041, a feature extraction unit 3042, a graph representation generation unit 3043, a labeling unit 3044, an integration unit 3045, and an estimation unit 3046.

The segmentation unit 3041 includes a trained semantic segmentation model. The semantic segmentation model may be located in the cloud or may be stored on a server or the like connected through a network. The segmentation unit 3041 uses the acquired image to execute high-accuracy pixel-level segmentation using, for example, U-Net or DeepLab, and divides the image into a plurality of segments (microscopic regions). The segmentation unit 3041 performs, for example, precise contour extraction, distinction of fine structures (wrinkles, sagging) on the surface of a flexible object, and clarification of boundaries with the background.

The feature extraction unit 3042 extracts feature amounts such as color, texture, position information, and depth information (as necessary) for each segment.

The graph representation generation unit 3043 uses segments as nodes to form edges on the basis of features such as proximity, similarity, positional relationship, and contact relationship.

The labeling unit 3044 uses, for example, a graph neural network (GNN) to simultaneously estimate node labels (whether a segment is part of a flexible object, a hand, the background, or the like) and edge labels (internal relationship within the same object, holding relationship, contact relationship, or the like). In a case where the captured image is a video frame, the labeling unit 3044 associates nodes between previous and next frames, and also processes a change in the time-series relationship using a GNN or an extended time-series model. The GNN is a type of deep learning model for processing data having a graph structure.

The integration unit 3045 integrates a group of segments constituting the same flexible object on the basis of the obtained labels and relationship information, assigns a label, and determines the group as a final object.

The estimation unit 3046 estimates the position, shape (degree of wrinkles, spread), and posture of the integrated flexible object.

### Segmentation Process

Next, an example of a segmentation process performed by the segmentation unit 3041 will be described.

The segmentation unit 3041 performs fine region segmentation (over-segmentation) on an input image using a high-accuracy semantic segmentation model such as U-Net or DeepLab. The semantic segmentation model is a model that creates a segmentation map of an image to be input. The U-Net is one type of fully convolution network (FCN), which is a network designed to estimate image segmentation (where objects are located). The DeepLab is a deep learning model that demonstrates high performance in the image recognition task called semantic segmentation.

This allows the segmentation unit 3041 to generate a plurality of segments (minute pixel regions) that cover the fine creases, wrinkles, complex contours, and the like of the flexible object without excess or deficiency.

However, at this stage, labeling is not performed, and processing is focused solely on subdividing the image into segment units. This results in maximizing the “accuracy of segmentation” in the present embodiment.

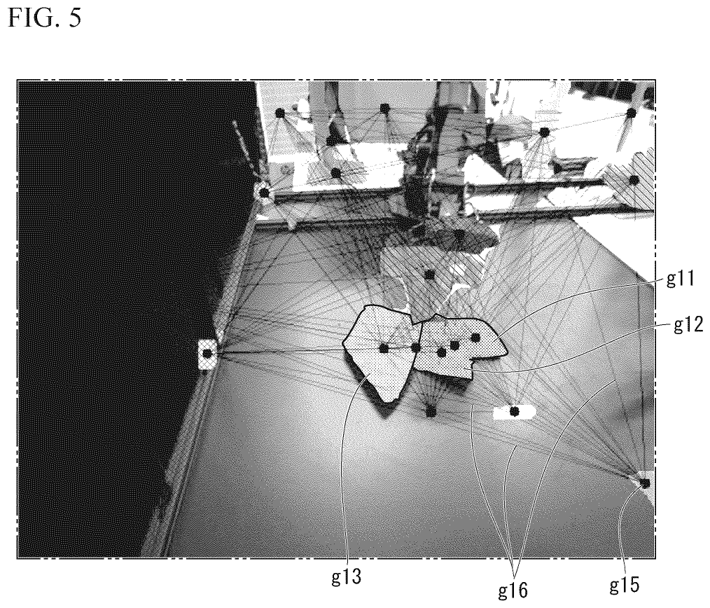

FIG. 5 is a diagram illustrating an example of a result obtained by performing a segmentation process on an image captured in a state where a handkerchief with creases or the like is present in a working space, and an example of performing a labeling process. In the example shown in FIG. 5, the end effector 4, the wall of the working space, and the like are also captured in the captured image.

In FIG. 5, each hatched portion is an example of each segment region. The object desired to be recognized is, for example, a handkerchief, which is equivalent to hatched regions g11, g12, and g13.

At this stage, extraction of contours, clarification of boundaries with the background, and distinction of the fine structures on the surface of the flexible object (such as, for example, wrinkles and sagging) are performed, but the handkerchief is not yet able to be recognized as one object.

### Feature Extraction Process

Next, an example of processing performed by the feature extraction unit 3042 will be described.

The feature extraction unit 3042 extracts feature amounts such as, for example, color, texture, position information, and depth information (as necessary) for each segment using, for example, a feature amount extraction algorithm. The feature amount extraction algorithm may be performed using a trained model such as, for example, a convolutional neural network (CNN), a visual geometry group (VGG), or a residual network (ResNet). Alternatively, the feature extraction unit 3042 may use a known method to extract Haar-Like feature amounts, histograms of oriented gradients (HOG) feature amounts, scale-invariant feature transform (SIFT) feature amounts, and the like.

### Labeling Process

Next, an example of a labeling process performed by the labeling unit 3044 will be described.

In FIG. 5, the circle g15 denotes a node, and the line g16 denotes an edge.

The labeling unit 3044 uses segments as nodes to form edges indicating the relationship between the nodes on the basis of features such as, for example, proximity, similarity, positional relationship, and contact relationship. The labeling unit 3044 uses, for example, a GNN to simultaneously estimate node labels (whether a segment is part of a flexible object, a hand, or the background) and edge labels (internal relationship within the same object, holding relationship, contact relationship, or the like). The relationships also include relationships specific to flexible objects, such as “being part of the same flexible object,” “a robot hand holding a flexible object,” and “being separate objects but in contact with each other.”

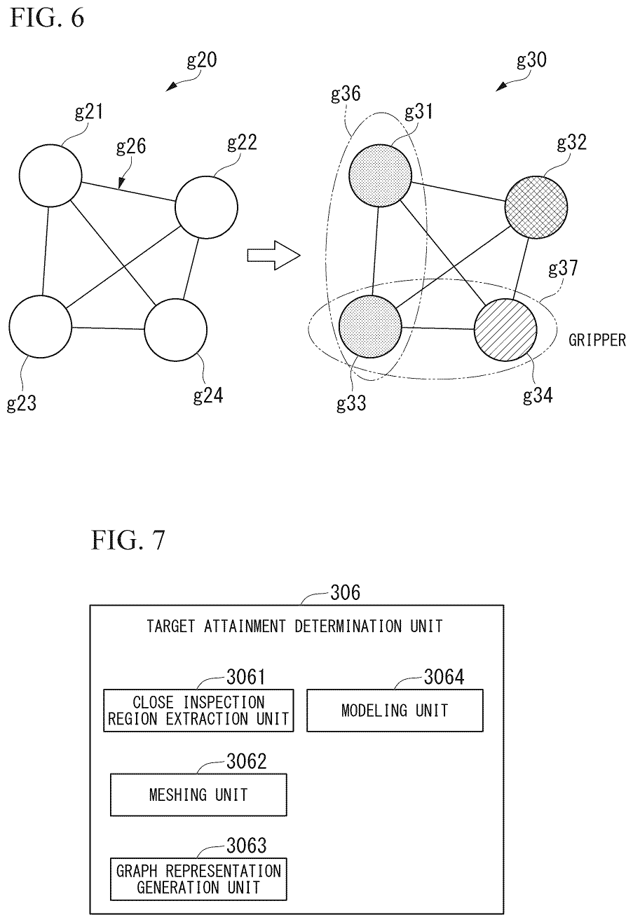

FIG. 6 is a diagram illustrating an example of graph representation and an example of a labeling process.

An image denoted by reference sign g20 is an example of graph representation after nodes and edges have been estimated. Circles g21 to g24 are nodes, and lines g26 connecting nodes are edges. At this stage, labeling has not been performed on each node.

An image denoted by reference sign g30 is an example after labeling.

As a result of estimation based on the relationship between nodes, the nodes g31 and g32 are examples in which these nodes are estimated to be nodes of a flexible object, and are estimated to be the same object like an ellipse g36. The node g32 is an example in which this node is estimated to be an environmental object (for example, other than the object or the end effector 4), and the node g34 is an example in which this node is estimated to be a gripper which is the hand 45 of the end effector 4. Like an ellipse g37, the nodes g33 and g34 are examples in which objects are estimated to be being gripped.

### Integration Process

Next, an example of an integration process performed by the integration unit 3045 will be described.

The integration unit 3045 analyzes the graph using a GNN to estimate, for example, node (segment) labels (whether a segment is part of a flexible object, a hand, or the background) and edges (relationships between segments). Thereby, according to the present embodiment, it is possible to integrate multiple separated segments and identify them as one flexible object, and to correctly understand a situation in which the flexible object and the hand move integrally.

Through this processing, the integration unit 3045 integrates a group of segments constituting the same flexible object on the basis of the obtained labels and relationship information, and determines the group as a final object.

### Estimation Process

Next, an example of an estimation process performed by the estimation unit 3046 will be described.

The estimation unit 3046 estimates the position of the integrated flexible object using a known image recognition method or the method disclosed in, for example, Japanese Patent Application No. 2024-216291.

The object detection relationship prediction unit 304 predicts the object's posture, state, relationship with another object through the above-described processing.

### Shape Prediction

Next, an example of processing performed by the shape prediction unit 305 will be described.

The shape prediction unit 305 estimates the shape (degree of wrinkles, spread) and posture of the integrated flexible object using a known image recognition method or the method disclosed in, for example, Japanese Patent Application No. 2024-216291.

### Unattained Region

Next, an example of processing performed by the target attainment determination unit 306 will be described.

FIG. 7 is a diagram illustrating a configuration example of the target attainment determination unit. The target attainment determination unit 306 includes, for example, a close inspection region extraction unit 3061, a meshing unit 3062, a graph representation generation unit 3063, and a modeling unit 3064.

First, the close inspection region extraction unit 3061 extracts, for example, as a close inspection region, a portion where the state of the flexible object (first object) may not have attained the target state on the basis of two-dimensional image information. This “close inspection region” refers to, for example, a critical region where it is necessary to determine in detail whether the flexible object is properly covered by a hard object.

In the present embodiment, subsequent three-dimensional detailed analysis is applied only to where the close inspection region is specified (high-accuracy three-dimensional acquisition is performed on a limited range, not on the entire region).

The acquisition unit 301 acquires high-accuracy three-dimensional data for the close inspection region using a depth camera or a three-dimensional scanner.

Next, the meshing unit 3062 meshes the region of the object within the acquired three-dimensional data.

Next, the graph representation generation unit 3063 represents the meshed image using nodes and edges. The graph representation generation unit 3063 assigns, to nodes, position embedding information (such as coordinates or curvature) which is information about the positions of the nodes, and assigns, to edges, relationship embedding information (such as distance between nodes, directionality, or difference in normal direction) which is information indicating the relationship between nodes. The embedding information is an embedded representation.

Next, the modeling unit 3064 inputs information on the entire mesh into the GNN, and models the distance dependency relationships and interactions of the entire mesh using an attention mechanism. Attention is a mechanism that dynamically specifies where to focus attention within the input data.

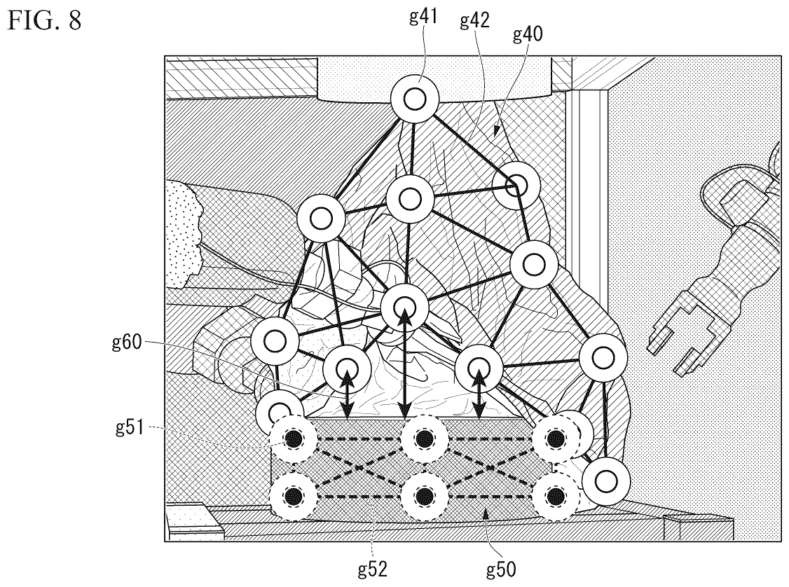

FIG. 8 is a diagram illustrating a target attainment determination process and a virtual external force. FIG. 8 is an example of a graph representation after passing through a voxel filter. This is an example in which processing is performed after increasing the mesh size. The mesh is a mesh in Fourier space. FIG. 8 shows these graph representations superimposed on the captured image.

Reference sign g40 denotes a flexible object which is a first object, reference sign g41 denotes a node in the first object, and reference sign g42 denotes an edge in the first object.

Reference sign g50 denotes a rigid body which is a second object, reference sign g51 denotes a node in the second object, and reference sign g52 denotes an edge in the second object.

The double-headed arrow g60 denotes the relationship between two objects and is a virtual external force.

Position embeddings (such as coordinates or curvature) are embedded in edges, and relationship embeddings (such as distance between nodes, directionality, or difference in normal direction) are embedded in edges.

The target attainment determination unit 306 can use information on position and curvature on a mesh included in the position embedding in which the nodes are embedded to easily calculate the degree of target attainment between two objects using a pair of nodes.

### Deformation Prediction

Next, a configuration example of the deformation prediction unit 307 and an example of processing will be described.

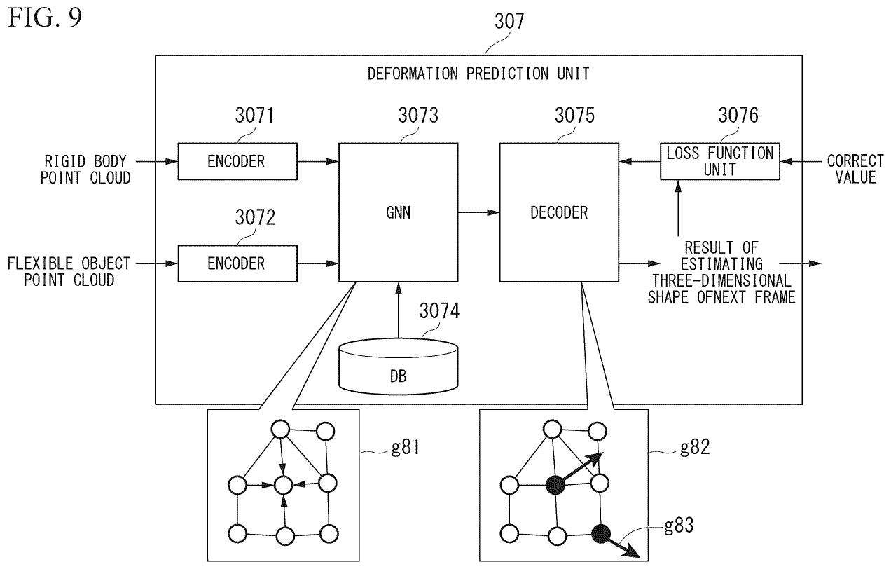

FIG. 9 is a diagram illustrating a configuration example of the deformation prediction unit.

The deformation prediction unit 307 includes, for example, an encoder 3071, an encoder 3072, a GNN 3073, a DB 3074, a decoder 3075, and a loss function unit 3076.

The encoder 3071 receives, for example, rigid body (second object) point cloud data and an external force as inputs. The encoder 3071 performs an encoding process in the transformer on the input rigid body (second object) point cloud data and external force, and outputs the encoded data to the GNN 3073. The rigid body (second object) point cloud data and the external force are generated or extracted from the image captured by the imaging unit 2, the detected three-dimensional data, and the data detected by the sensor 43.

The encoder 3072 receives, for example, flexible object (first object) point cloud data and an external force as inputs. The encoder 3071 performs an encoding process in the transformer on the input flexible portion (first object) point cloud data and external force, and outputs the encoded data to the GNN 3073. The flexible object (first object) point cloud data and external force are generated or extracted from the image captured by the imaging unit 2, the detected three-dimensional data, and the data detected by the sensor 43.

The GNN 3073 uses the data input from the encoder 3071 and the encoder 3072 to create a graph representation (reference sign g81), and refers to the DB 3074 to predict the deformation of the flexible object due to an external force using the GNN from the relationship between the nodes and edges.

The DB 3074 is, for example, a database of a three-dimensional shape using position vectors as external forces.

The decoder 3075 performs a decoding process in the transformer on the data processed by the GNN 3073, and outputs the result of predicting the three-dimensional shape of the next frame. The decoder 3075 performs updating on the basis of the cost of the loss function output by the loss function unit 3076. Reference sign g82 denotes an image of the decoding process of the decoder 3075, and arrow g83 denotes an image of the direction and amount of deformation of the flexible object due to an external force.

The loss function unit 3076 compares the result of predicting the three-dimensional shape of the next frame output by the decoder 3075 with the correct value to obtain a loss function, and outputs the obtained result to the decoder 3075.

The configuration shown in FIG. 9 and the processing content described above are merely an example, and deformation prediction is not limited to this.

### Motion Generation Process

Next, a configuration example of the motion generation unit 310 and an example of processing will be described.

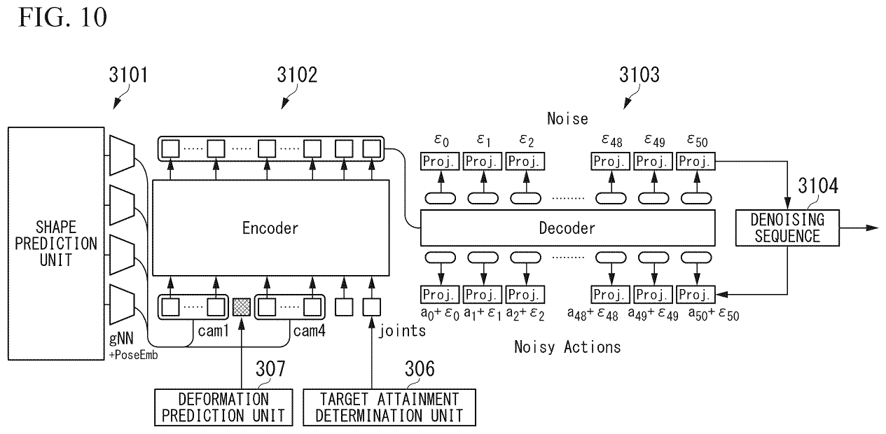

FIG. 10 is a diagram illustrating a configuration example of the motion generation unit.

The motion generation unit 310 includes, for example, a CNN 3101, an encoder 3102, a decoder 3103, and a denoising sequence 3104.

The CNN 3101 is a convolutional neural network, and includes a pre-processing unit before input. The CNN 3101 receives, as an input, three-dimensional data output by the shape prediction unit 305, for example, for each imaging unit 2. The CNN 3101 outputs, for example, the processing result for each imaging unit 2 to each input of the encoder 3102.

The encoder 3102 is an encoder in the transformer. The encoder 3102 receives, as inputs, the processed data from the CNN 3101, the determination result from the target attainment determination unit 306, and the data predicted from the deformation prediction unit 307. The encoder 3102 receives, as inputs, GNN output (future shape prediction) of the deformation prediction unit 307 as well as the current shape, directionality information (guidance vector), joint angle state, and the like, and integrates them into a latent space representation. The encoder 3102 performs an encoding process in the transformer on the input data and outputs the data to the decoder 3103.

The decoder 3103 is a decoder in the transformer. The decoder 3103 performs a decoding process in the transformer on the data input from the encoder 3102 and outputs a motion instruction to the end effector 4. For example, the decoder 3103 calculates the physical target point and direction to be attained by the end effector from the latent representation. The decoder 3103 generates the joint angle sequence directly using a trained decoder. The joint angle sequence may be calculated by the motion generation unit 310 using inverse kinematics (IK) to attain the target point.

The denoising sequence 3104 performs a denoising process on the data output by the decoder 3103.

### Processing Flow of Control Device

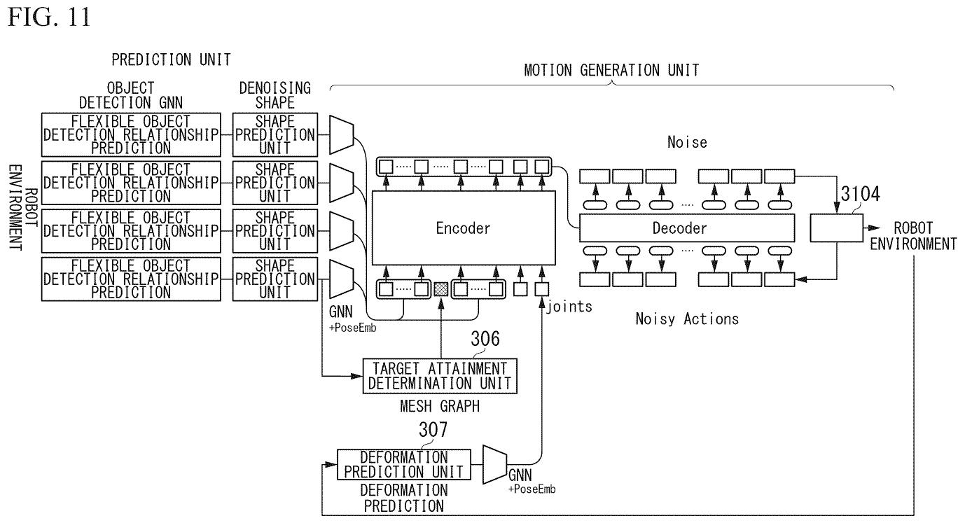

FIG. 11 is a diagram illustrating an example of a processing flow of the control device of the present embodiment.

First, the object detection relationship prediction unit 304 uses the data acquired from the robot environment to detect a flexible object and predict its relationship with another object.

Next, the shape prediction unit 305 predicts the shape of the flexible object using the data output by the object detection relationship prediction unit 304.

Next, the target attainment determination unit 306 uses the information on position and curvature on the mesh to calculate the degree of target attainment between two objects using a pair of nodes, thereby calculating the deviation from the target (reference object) and performing target attainment determination.

Next, the deformation prediction unit 307 predicts the deformation of the flexible object using the data acquired from the robot environment.

The motion generation unit 310 inputs the output data of the shape prediction unit 305, the output data of the target attainment determination unit 306, and the output data of the deformation prediction unit 307 into the encoder of the transformer, and calculates the physical target point and direction to be attained by the end effector. The motion generation unit 310 generates the joint angle sequence directly using a trained decoder.

The robot is caused to execute the trajectory obtained in this way, thereby enabling actual manipulation.

### Re-Learning

Next, re-learning using imitation learning data will be described.

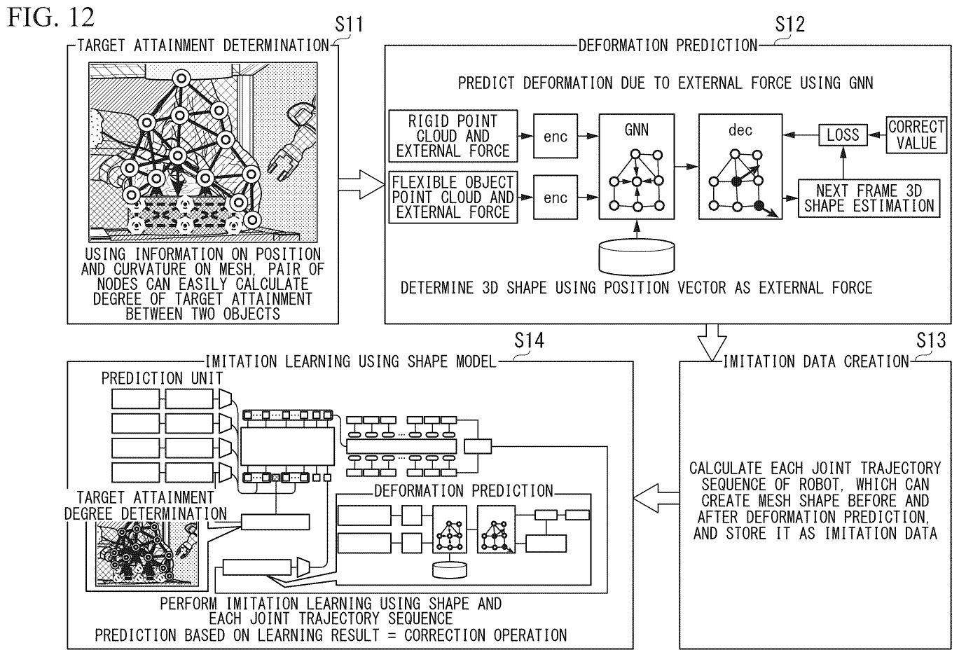

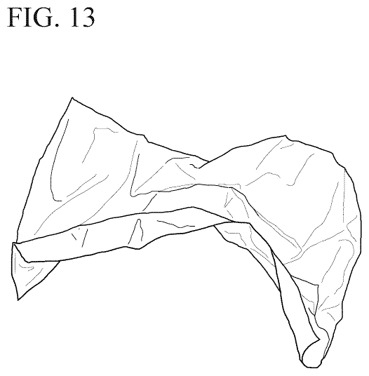

FIG. 12 is a diagram illustrating an example of a schematic processing procedure for re-learning using imitation learning data.

(Step S11) The target attainment determination unit 306 uses the information on position and curvature on the mesh to calculate the degree of target attainment between two objects using a pair of nodes, thereby calculating the deviation from the target (reference object) and performing target attainment determination.

(Step S12) The deformation prediction unit 307 predicts the deformation of the flexible object due to an external force using the data acquired from the robot environment.

(Step S13) The imitation data creation unit 308 stores, as imitation data, each joint trajectory sequence of the robot calculated by the motion generation unit 310, the robot being capable of creating mesh shapes before and after deformation prediction.

(Step S14) The learning unit 309 uses the imitation data to perform imitation learning using the shape and each joint trajectory sequence.

This allows prediction, that is, correction operation, to be performed on the basis of the learning results.

The learning unit 309 may use reinforcement learning and nonlinear optimization techniques in combination to improve and adapt the strategy in many ways.

### Target Task

Next, an example of a target task in the present embodiment will be described.

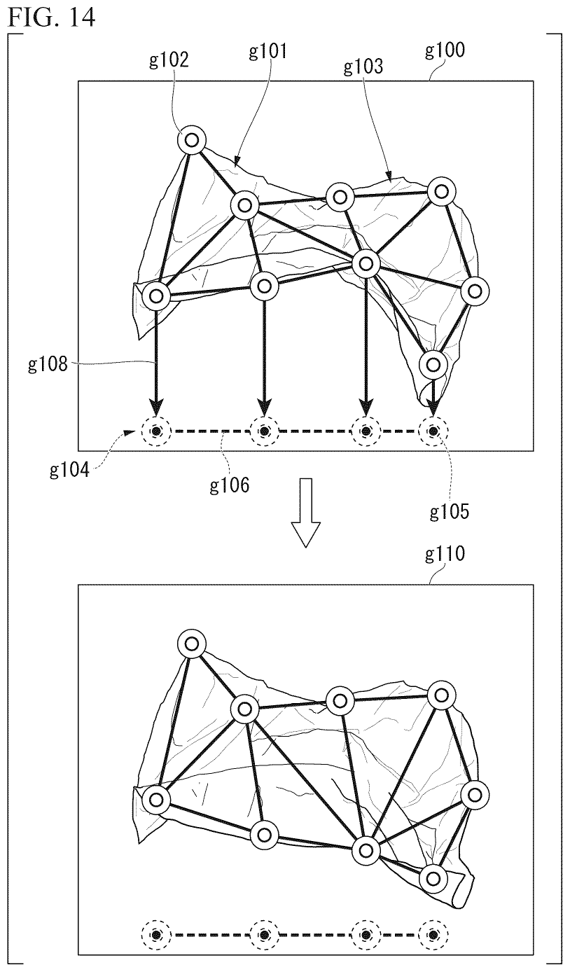

FIG. 13 is an example of wrinkled or creased paper before stretching.

For example, the target task is assumed to be “unfolding a sheet of paper on a desk at a location where the paper can be spread out.” In such a case, it is necessary to find a location which is convenient for operation based on the shape.

FIG. 14 is a diagram illustrating an example of a current shape and a shape (future state) after application of a virtual external force.

The image g100 is an example of the current image with nodes and edges of a graph representation superimposed on the image. Reference sign g101 denotes an image of the paper in the current state, the circle g102 denotes a node of the paper, and the line g103 denotes an edge of the paper. The arrow g104 denotes the desktop, the circle g105 denotes a node on the desktop, and the line g106 denotes an edge on the desktop.

The arrow g108 denotes the direction of the goal.

The image g110 is an example of an image after application of a virtual external force with nodes and edges of a graph representation superimposed on the image.

As shown in FIG. 13, in a case where the difference from the goal state can be understood by referring to nodes at important locations in the graph, it is possible to estimate the next shape and to find a good location required for operation.

Therefore, in the present embodiment, the shape after application of an external force is predicted and used.

As described above, in the present embodiment, the following processing and the like are performed.

### I. Redefining Unattained Region as Virtual External Force to Predict Future Shape

In the present embodiment, the unattained portion is treated not as a mere error or defect but as an abstract representation of a virtual external force. Thereby, in the present embodiment, the GNN can be used to estimate the future shape (next shape) of a cloth under the action of an external force with a high degree of accuracy.

### II. Integration of Latent Representations Using GNN and Transformer

In the present embodiment, the point cloud and mesh information of a flexible object are analyzed using a GNN to predict the future shape in a case where a virtual external force is applied. Further, in the present embodiment, the transformer is used to multi-dimensionally aggregate the current shape, directionality information (for example, the guidance vector of the target location), joint angle state, and future shape prediction result into a latent space.

Thereby, in the present embodiment, the latent representation simplifies and compresses complex relationships, enabling advanced feature amount extraction.

This multi-stage information integration can provide a new foundation for unprecedented intelligent manipulation of flexible objects.

### III. Generation of Joint Angle Sequence Using Inverse Kinematics and Trained Decoder

In the present embodiment, the “desirable shape change direction” obtained from the latent representation is directly converted into a joint angle sequence using inverse kinematics (IK) or a trained decoder.

Conventional IK was limited to the simple attainment of a fixed target point. On the other hand, in the present embodiment, “latent shape-guided IK” was used in a two-stage process in which the shape guidance guideline suggested in the latent space is first mapped to the target position and direction of the end effector, and then a conventional IK solver is used to obtain the joint angle sequence. That is, in the present embodiment, the motion generation unit 310 maps the shape guidance guideline suggested in the latent space to the target position and direction of the end effector 4 (device), and then obtains the joint angle sequence using an inverse kinematics solver.

Thereby, in the present embodiment, using a trained decoder enables the instant generation of joint trajectories from the latent space, which makes it possible to acquire a flexible manipulation measure while omitting the IK calculation itself. Alternatively, according to the present embodiment, the joint angle sequence can be obtained using the “latent shape-guided IK” through a required two-stage process.

These approaches can provide new insights that directly link shape guidance and action generation, rather than simple coordinate attainment.

### IV. Expansion of Imitation Learning Data Using Generated Joint Angle Sequence

In the present embodiment, the joint angle sequence automatically generated on the basis of the latent representation and future shape prediction can be used as a dataset for imitation learning.

Thereby, according to the present embodiment, new behavioral patterns can be virtually generated to address issues such as a lack of data and dealing with unknown tasks, allowing the robot to learn a variety of operational strategies. As a result, in this embodiment, it is possible to learn a more versatile and adaptable strategy.

### V. Multifaceted Extensibility Through Combination of Reinforcement Learning and Nonlinear Optimization

In the present embodiment, in addition to future shape prediction using GNN—or transformer-based latent representations and virtual external forces, it is also possible to introduce examples of a learning process of rewarding directionality through reinforcement learning and local cost minimization through nonlinear optimization (for Example, iLQR or MPC).

Thereby, in the present embodiment, this multi-method hybrid strategy makes it possible to generate and improve an optimal trajectory in accordance with the situation, and to further improve the versatility and accuracy of flexible object manipulation.

Thereby, according to the present embodiment, the following can be achieved.
Improved accuracy: By treating a target unattained region as a virtual external force, it becomes possible to predict forward-looking deformation, which leads to an improvement in the accuracy of robot manipulation.
Flexible adaptability: By utilizing the generated joint angle sequence for imitation learning, it is possible to quickly adapt to unknown flexible object shapes and new tasks.
Improved efficiency: The scope of automation expands, which can be expected to reduce work time and improve productivity.

In the above-described example, the control device 3 controls the end effector 4 to perform a task, but there is no limitation thereto. The end effector 4 may be operated by an operator operating an operation unit to issue a remote operation instruction, and the control device 3 may control the end effector 4 in accordance with this instruction. The end effector 4 may have two arms or three or more arms.

A program for realizing all or some of functions of the control device 3 in the present invention is recorded in a computer readable recording medium, and thus all or some of processes performed by the control device 3 may be performed by causing a computer system to read and execute the program recorded in this recording medium. The term “computer system” referred to here is assumed to include an OS and hardware such as peripheral devices. The term “computer system” is also assumed to include a WWW system equipped with a homepage providing environment (or display environment). The term “computer readable recording medium” refers to a portable medium such as a flexible disk, a magneto optic disc, a ROM, or a CD-ROM, and a storage device such as a hard disk built into a computer system. Further, the term “computer readable recording medium” is also assumed to include a medium that holds a program for a certain period of time, such as a volatile memory (RAM) within a computer system serving as a server or client when the program is transmitted through a network such as the Internet or a communication line such as a telephone line.

Alternatively, Some or all of these components may be realized by hardware (a circuit unit; including circuitry) such as a large scale integration (LSI), an application specific integrated circuit (ASIC), a field-programmable gate array (FPGA), a graphics processing unit (GPU), or a system on chip (SOC), and may be realized by software and hardware in cooperation.

The above program may be transmitted from a computer system in which this program is stored in a storage device or the like to another computer system through a transmission medium or by transmission waves in the transmission medium. Here, the term “transmission medium” that transmits a program refers to a medium having a function of transmitting information, like a network (communication network) such as the Internet or a communication line (communication cable) such as a telephone line. The above program may be intended to implement some of the above-described functions. Further, the above-described functions may be implemented in combination with a program already recorded in the computer system, that is, a so-called difference file (difference program).

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A control device configured to manipulate an object using a device having controllable joints, the control device comprising:
a target state setting unit configured to set a target state of the object;
an acquisition unit configured to acquire a current state of the object;
a prediction unit configured to predict a future state of the object in a case where a difference vector between the target state and the current state is applied; and
a motion generation unit configured to aggregate the current state, information on directionality from the current state to the target state, a joint angle state of the device, and a prediction result of the future state into a latent space, generate a shape change direction up to the target state, and obtain a joint angle of the device from the shape change direction.

2. The control device according to claim 1, further comprising a motion control unit configured to control the device to the obtained joint angle,
wherein the motion generation unit aggregates a device status resulting from controlling the device and a state of the object after the object is deformed by the device into a latent space, and outputs a new shape change direction to the target state.

3. The control device according to claim 1, further comprising:
a target attainment determination unit configured to compare the target state with the current shape, specify an unattained region that has not yet attained the target state, assign, to the unattained region, a guideline indicating that stretching a cloth in this direction brings the cloth closer to a target, abstract the guideline as a force vector to be treated as a virtual external force, and calculate a degree of target attainment; and
a deformation prediction unit configured to predict deformation of the object due to the virtual external force using the acquired current state of the object,
wherein the motion generation unit uses the degree of target attainment calculated by the target attainment determination unit and a shape of the object after application of the virtual external force predicted by the deformation prediction unit to aggregate a prediction result of the future state into the latent space, generate a shape change direction up to the target state, and obtain a joint angle of the device from the shape change direction.

4. The control device according to claim 1, wherein the motion generation unit maps a shape guidance guideline suggested in the latent space to a target position and direction of the device, and then obtains a joint angle sequence using an inverse kinematics solver.

5. The control device according to claim 1, further comprising a learning unit configured to re-train a control model of the device using, as a dataset for imitation learning, a sequence of joint angles generated on the basis of a latent representation expressed in the latent space and the prediction result of the future state after application of a virtual external force.

6. The control device according to claim 3, wherein the acquired current state of the object includes point cloud data of the object and information indicating an external force, and
the deformation prediction unit uses the point cloud data of the object and the information indicating an external force to estimate a three-dimensional shape of the object using a position vector as an external force, and predict deformation due to the external force using a graph neural network (GNN).

7. The control device according to claim 3, wherein the target attainment determination unit uses information on position and curvature on a mesh to calculate the degree of target attainment between the object and another object using a pair of nodes in a graph representation.

8. A control method for manipulating an object using a device having controllable joints, the control method comprising:
a target setting step of setting a target state of the object;
an acquisition step of acquiring a current state of the object;
a prediction step of predicting a future state of the object in a case where a difference vector between the target state and the current state is applied; and
a motion generation step of aggregating the current state, information on directionality from the current state to the target state, a joint angle state of the device, and a prediction result of the future state into a latent space, generating a shape change direction up to the target state, and obtaining a joint angle of the device from the shape change direction.

9. The control method according to claim 8, further comprising:
a motion control step of controlling the device to the obtained joint angle; and
a step of aggregating a device status resulting from controlling the device and a state of the object after the object is deformed by the device into a latent space, and outputting a new shape change direction to the target state.

10. The control method according to claim 8, further comprising a re-training step of re-training a control model of the device using, as a dataset for imitation learning, a sequence of joint angles generated on the basis of a latent representation expressed in the latent space and the prediction result of the future state after application of a virtual external force.
